(19) United States
(12) Patent Application Publication
(10) Pub. No.: US 2007/0102374 A1
(43) Pub. Date: May 10, 2007

(54) BLOOD PROCESSING APPARATUS WITH CONTROLLED CELL CAPTURE CHAMBER AND METHOD BACKGROUND OF THE INVENTION

(75) Inventor: Jeremy Kolenbrander, Brighton, CO (US)

Correspondence Address: GAMBRO, INC;PATENT DEPARTMENT, 10810 W COLLINS AVE, LAKEWOOD, CO, 80215, US

(73) Assignee: GAMBRO, INC., Lakewood, CO (US)

(21) Appl. No.: 11/163,969

(22) Filed: Nov. 4, 2005

(51) Int. Cl. C02F 1/38

(52) U.S. Cl. 210/787; 210/512.1; 210/94; 494/1; 494/10

(57) ABSTRACT

A centrifuge for separating blood components, and methods for controlling the centrifuge. The apparatus has a fluid separation chamber having a first frustro-conical segment and a second frustro-conical segment. The second segment has a taper such that particles are subjected to substantially equal and opposite centripetal and fluid flow forces. A camera observes fluid flow, and a controller controls the flow. White blood cells are selectively captured within the second segment and are periodically flushed out of the fluid separation chamber. The camera is used to determine the quantity of particles captured. A limited quantity of high density particles, such as red blood cells, may be captured within the first segment before capturing relatively low density particles, such as white blood cells, within the second segment.

This application is related to U.S. Pat. No. 5,722,926, issued Mar. 3, 1998; U.S. Pat. No. 5,951,877, issued Sep. 14, 1999; U.S. patent 6,053,856, issued Apr. 25, 2000; U.S. patent 6,334,842, issued Jan. 1, 2002; U.S. patent application Ser. No. 10/884,877 filed Jul. 1, 2004; and U.S. patent application Ser. No. 10/905,353, filed Dec. 29, 2004. The entire disclosure of each of these U.S. patents and patent applications is incorporated herein by reference.

### FIELD OF THE INVENTION

The present invention relates to an apparatus and method for separating particles or components of a fluid. The invention has particular advantages in connection with separating blood components, such as white blood cells and platelets.

### DESCRIPTION OF THE RELATED ART

In many different fields, liquids carrying particle substances must be filtered or processed to obtain either a purified liquid or purified particle end product. In its broadest sense, a filter is any device capable of removing or separating particles from a substance. Thus, the term “filter” as used herein is not limited to a porous media material but includes many different types of devices and processes where particles are either separated from one another or from liquid.

In the medical field, it is often necessary to filter blood. Whole blood consists of various liquid components and particle components. The liquid portion of blood is largely made up of plasma, and the particle components include red blood cells (erythrocytes), white blood cells (leukocytes), and platelets (thrombocytes). While these constituents have similar densities, their average density relationship, in order of decreasing density, is as follows: red blood cells, white blood cells, platelets, and plasma. In addition, the particle components are related according to size, in order of decreasing size, as follows: white blood cells, red blood cells, and platelets. Most current purification devices rely on density and size differences or surface chemistry characteristics to separate and/or filter the blood components.

Typically, donated platelets are separated or harvested from other blood components using a centrifuge. White cells or other selected components may also be harvested. The centrifuge rotates a blood separation vessel to separate components within the vessel or reservoir using centrifugal force. In use, blood enters the separation vessel while it is rotating at a very rapid speed and centrifugal force stratifies the blood components, so that particular components may be separately removed. Components are removed through ports arranged within stratified layers of blood components.

White blood cells and platelets in plasma form a medium density stratified layer or “buffy coat”. Because typical centrifuge collection processes are unable to consistently and satisfactorily separate white blood cells from platelets in the buffy coat, other processes have been added to improve results. In one procedure, after centrifuging, platelets are passed through a porous woven or non-woven media filter, which may have a modified surface, to remove white blood cells. However, use of the porous filter introduces its own set of problems. Conventional porous filters may be inefficient because they may permanently remove or trap approximately 5-20% of the platelets. These conventional filters may also reduce “platelet viability” meaning that once passed through a filter a percentage of the platelets cease to function properly and may be partially or fully activated. In addition, porous filters may cause the release of bradykinin, an inflammation mediator and vasodialator, which may lead to hypotensive episodes in a patient. Porous filters are also expensive and often require additional time-consuming manual labor to perform a filtration process. Although porous filters are effective in removing a substantial number of white blood cells, activated platelets may clog the filter. Therefore, the use of at least some porous filters is not feasible in on-line processes.

Another separation process is one known as centrifugal elutriation. This process separates cells suspended in a liquid medium without the use of a membrane filter. In one common form of elutriation, a cell batch is introduced into a flow of liquid elutriation buffer. This liquid, which carries the cell batch in suspension, is then introduced into a funnel-shaped chamber located on a spinning centrifuge. As additional liquid buffer solution of a given density flows through the chamber, the liquid sweeps smaller sized, slower-sedimenting cells toward an elutriation boundary within the chamber, while larger, faster-sedimenting cells migrate to an area of the chamber having the greatest centrifugal force.

When the centrifugal force and force generated by the fluid flow are balanced, the fluid flow is increased to force slower-sedimenting cells from an exit port in the chamber, while faster-sedimenting cells are retained in the chamber. If fluid flow through the chamber is increased, progressively larger, faster-sedimenting cells may be removed from the chamber.

Thus, centrifugal processing separates particles having different sedimentation velocities. Stoke's law describes sedimentation velocity (V_{S}) of a spherical particle as follows:
V_{S}=(((D²_{cell}*(ρ_{cell}−ρ_{medium}))/(18*μ_{medium}))*ω²r
where D is the diameter of the cell or particle, ρ_{cell} is the density of the particle, ρ_{medium} is the density of the liquid medium, μ_{medium} is the viscosity of the medium, and ω is the angular velocity and r is the distance from the center of rotation to the cell or particle. Because the diameter of a particle is raised to the second power in Stoke's equation and the density of the particle is not, the size of a cell, rather than its density, greatly influences its sedimentation rate. This explains why larger particles generally remain in a chamber during centrifugal processing, while smaller particles are released, if the particles have similar densities.

As described in U.S. Pat. No. 3,825,175 to Sartory, centrifugal elutriation has a number of limitations. In most of these processes, particles must be introduced within a flow of fluid medium in separate, discontinuous batches to allow for sufficient particle separation. Thus, some elutriation processes only permit separation in particle batches and require an additional fluid medium to transport particles. In addition, flow forces must be precisely balanced against centrifugal force to allow for proper particle segregation.

For these and other reasons, there is a need to improve particle separation and/or separation of components of a fluid.

### SUMMARY OF THE INVENTION

The present invention comprises a centrifuge for separating particles suspended in a fluid, particularly blood and blood components, and methods for controlling the centrifuge. The apparatus has a fluid separation chamber mounted on a rotor, the fluid separation chamber having a fluid inlet and a fluid outlet, the fluid inlet being radially outward from the fluid outlet, a first frustro-conical segment adjacent the fluid inlet and radially inward therefrom, a second frustro-conical segment immediately adjacent the first frustro-conical segment and radially inward therefrom, the second frustro conical segment having a taper such that particles within the second frustro-conical segment are subjected to substantially equal and opposite centrifugal and fluid flow forces. The taper of the second frustro-conical segment is selected based on the expected size of particles and expected flow rates, such that at least particles of the average size of expected particles will be subjected to substantially equal and opposite centripetal and fluid forces. The taper may be at least 2.8°, more preferably about 3.0°, such that particles having a size greater than the average size of expected particles will be subjected to such equal and opposite forces. Preferably, the first frustro-conical segment has a greater taper than the second frustro-conical segment.

The apparatus may further comprise at least one pump controlling a rate of fluid flow through the fluid separation chamber, a camera configured to observe fluid flow with respect to the fluid separation chamber, and a controller receiving signals from the camera and controlling the motor and the pump. Particles, such as white blood cells, are selectively captured within the second frustro-conical segment in said fluid separation chamber and flushed out of the fluid separation chamber. The quantity of particles captured within said second frustro-conical segment may be determined using data derived from the camera. In addition, a limited quantity of relatively high density particles, such as red blood cells, may be captured within the first frustro-conical segment before capturing relatively low density particles, such as white blood cells, within the second frustro-conical segment.

It is to be understood that both the foregoing general description and the following detailed description are exemplary, and are intended to provide further explanation of the invention as claimed.

### BRIEF DESCRIPTION OF THE DRAWINGS

FIG. 1 is a partial perspective view of a centrifuge apparatus including a fluid chamber in accordance with an embodiment of the invention.

FIG. 2 is a partial perspective, schematic view of the centrifuge apparatus and a control camera.

FIG. 3 is a perspective view of a blood processing apparatus with control camera and lighting.

FIG. 4 is a top plan view of the blood processing apparatus of FIG. 3.

FIG. 5 is a partial cross-sectional view of blood processing apparatus of FIG. 4 including the centrifuge and fluid chamber of FIG. 1.

FIG. 6 is a partial cross-sectional, schematic view of a portion of a separation vessel and the fluid chamber mounted on a centrifuge rotor of FIG. 1.

FIG. 7 is an exploded plan view of the fluid chamber of FIG. 1.

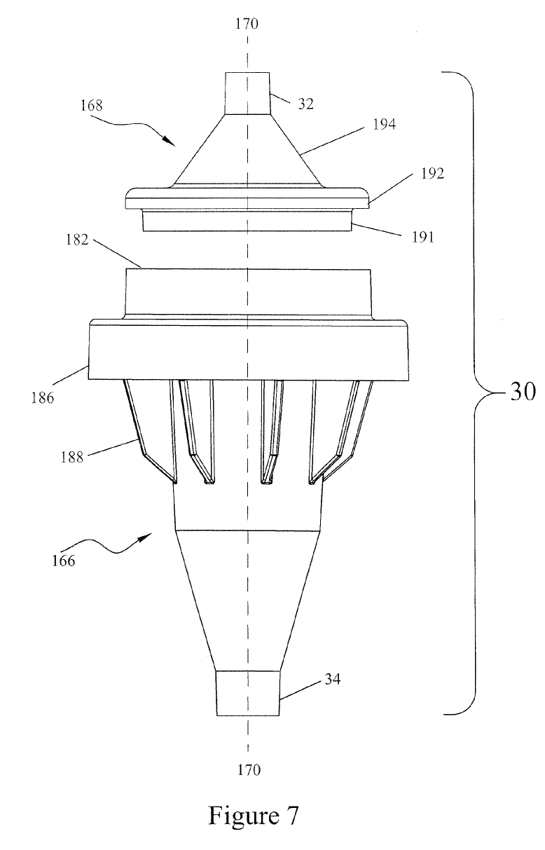

FIG. 8 is a cross-sectional view of the fluid chamber of FIG. 7.

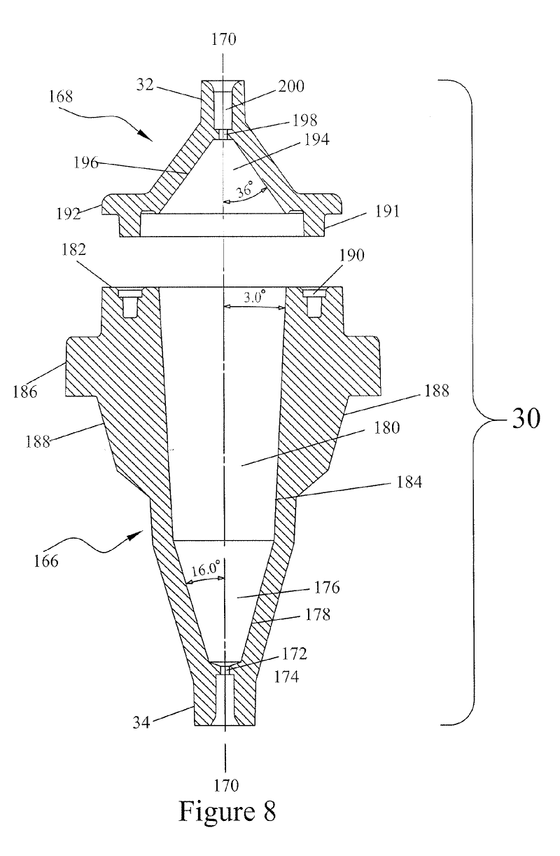

FIG. 9 is a perspective view of a tubing set including the fluid chamber and an alternative embodiment of the separation vessel.

FIG. 10 is a flow chart of steps for processing blood in the blood processing apparatus.

FIG. 11 is a plan view of a separation chamber of the separation vessel of FIGS. 6 and 9.

FIG. 12 is a partial perspective, schematic view of an alternative centrifuge apparatus and a two control cameras.

FIG. 13 is a cross-sectional plan view of the fluid chamber of FIG. 1.

### DETAILED DESCRIPTION

To describe the present invention, reference will now be made to the accompanying drawings.

The present invention preferably comprises a blood processing apparatus having a camera control system, as disclosed in U.S. patent applications Ser. Nos. 10/884,877 and 10/905,353. It may also be practiced with a TRIMA® blood component centrifuge manufactured by Gambro BCT, Inc. of Colorado or, alternatively, with a COBE® SPECTRA™ single-stage blood component centrifuge also manufactured by Gambro BCT, Inc. Both the TRIMA® and the SPECTRA™ centrifuges incorporate a one-omega/two-omega sealless tubing connection as disclosed in U.S. Pat. No. 4,425,112 to Ito, the entire disclosure of which is incorporated herein by reference. The SPECTRA™ centrifuge also uses a single-stage blood component separation channel substantially as disclosed in U.S. Pat. No. 4,094,461 to Kellogg et al. and U.S. Pat. No. 4,647,279 to Mulzet et al., the entire disclosures of which are also incorporated herein by reference. The invention could also be practiced with a TRIMA® or TRIMA ACCEL® centrifugal separation system or other types of centrifugal separator. The method of the invention is described in connection with the aforementioned blood processing apparatus and camera control system for purposes of discussion only, and this is not intended to limit the invention in any sense.

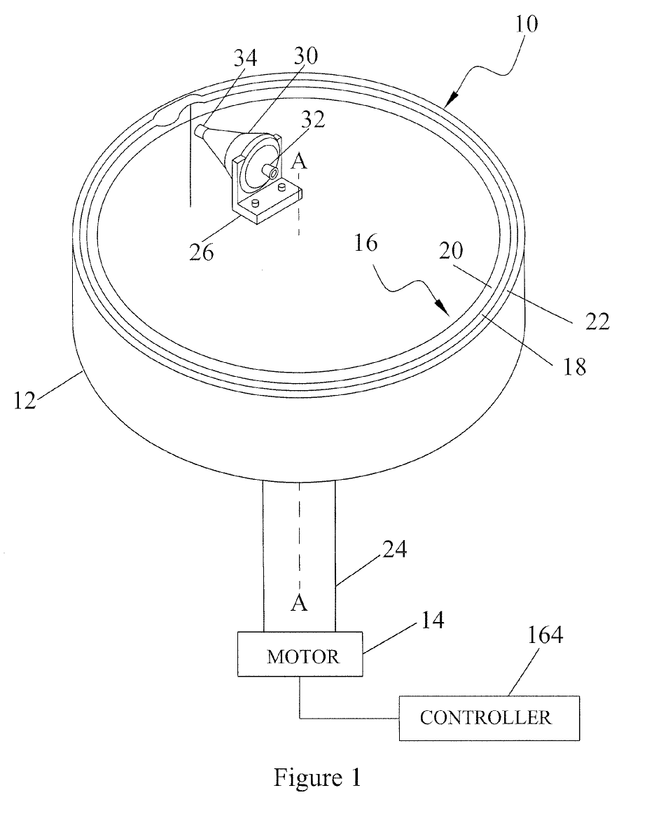

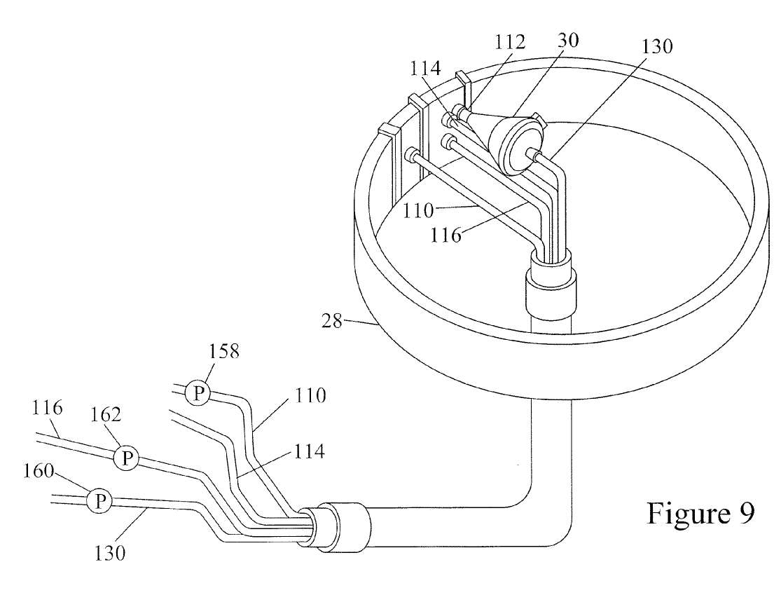

As embodied herein and illustrated in FIG. 1, a centrifuge apparatus 10 has a centrifuge rotor 12 coupled to a motor 14 so that the centrifuge rotor 12 rotates about its axis of rotation A-A. The rotor 12 has a retainer 16 including a passageway or annular groove 18 having an open upper surface adapted to receive a separation vessel 28, shown in FIG. 9. The groove 18 completely surrounds the rotor's axis of rotation A-A and is bounded by an inner wall 20 and an outer wall 22 spaced apart from one another to define the groove 18 therebetween. Although the groove 18 shown in FIG. 1 completely surrounds the axis of rotation A-A, the groove could partially surround the axis A-A when the separation vessel is not annular.

Preferably, a substantial portion of the groove 18 has a constant radius of curvature about the axis of rotation A-A and is positioned at a maximum possible radial distance on the rotor 12. This shape ensures that substances separated in the separation vessel 28 undergo relatively constant centrifugal forces as they pass from an inlet portion to an outlet portion of the separation vessel 28. The motor 14 is coupled to the rotor 12 directly or indirectly through a shaft 24 connected to the rotor 12. Alternately, the shaft 24 may be coupled to the motor 14 through a gearing transmission (not shown).

As shown in FIG. 1, a bracket 26 is provided on a top surface of the rotor 12. The bracket 26 releasably holds a fluid chamber 30 on the rotor 12 so that an outlet 32 of the fluid chamber 30 is positioned closer to the axis of rotation A-A than an inlet 34 of the fluid chamber 30. The bracket 26 preferably orients the fluid chamber 30 on the rotor 12 with a longitudinal axis of the fluid chamber 30 in a plane transverse to the rotor's axis of rotation A-A. In addition, the bracket 26 is preferably arranged to hold the fluid chamber 30 on the rotor 12 with the fluid chamber outlet 32 facing the axis of rotation A-A. Although the fluid chamber 30 is shown on a top surface of the rotor 12, the fluid chamber 30 could also be secured to the rotor 12 at alternate locations, such as beneath the top surface of the rotor 12.

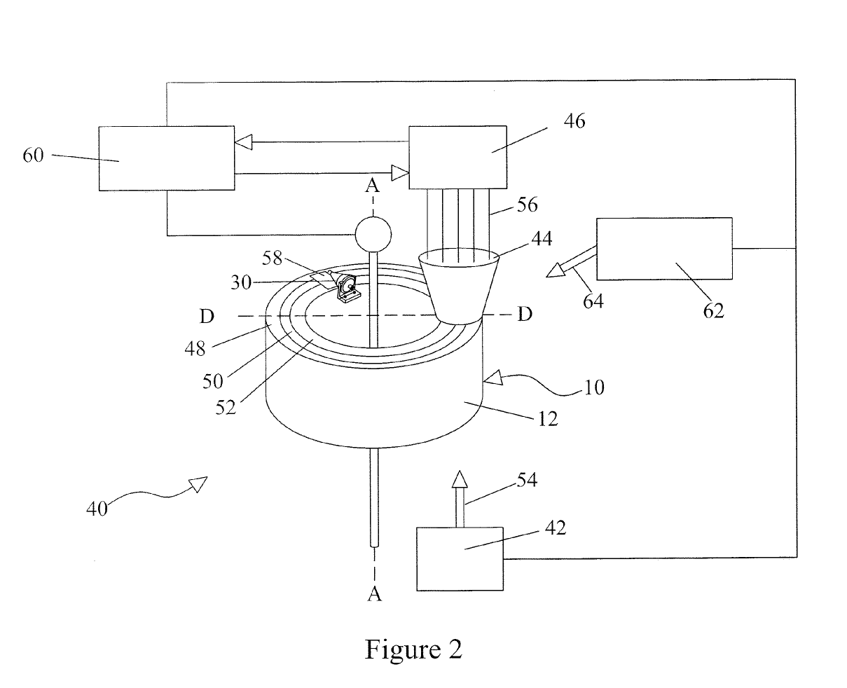

FIG. 2 schematically illustrates an exemplary embodiment of an optical monitoring system 40 capable of measuring a distribution of scattered and/or transmitted light intensities corresponding to patterns of light originating from an observation region on the separation vessel 28. The monitoring system 40 comprises light source 42, light collection element 44, and detector 46. Light source 42 is in optical communication with the centrifuge apparatus 10 comprising rotor 12, which rotates about central rotation axis A-A. Rotation about central rotation axis A-A results in separation of a blood sample in the separation vessel 28 into discrete blood components along a plurality of rotating separation axes oriented orthogonal to the central rotation axis A-A.

Light source 42 provides incident light beam 54, which stroboscopically illuminates an observation region 58 when the observation region 58 passes under the light collection element 44. Light source 42 is capable of generating an incident light beam, a portion of which is transmitted through at least one blood component undergoing separation in separation vessel 28. At least a portion of scattered and/or transmitted light 56 from the observation region 58 is collected by light collection element 44. Light collection element 44 is capable of directing at least a portion of the collected light 56 onto detector 46. The detector 46 detects patterns of scattered and/or transmitted light 56 from the observation region, thereby measuring distributions of scattered and/or transmitted light intensities. Distributions of scattered and/or transmitted light intensities comprise images corresponding to patterns of light originating from the observation region 58. The images may be monochrome images, which provide a measurement of the brightness of separated blood components along the separation axis. Alternatively, the images may be color images, which provide a measurement of the colors of separated blood components along the separation axis.

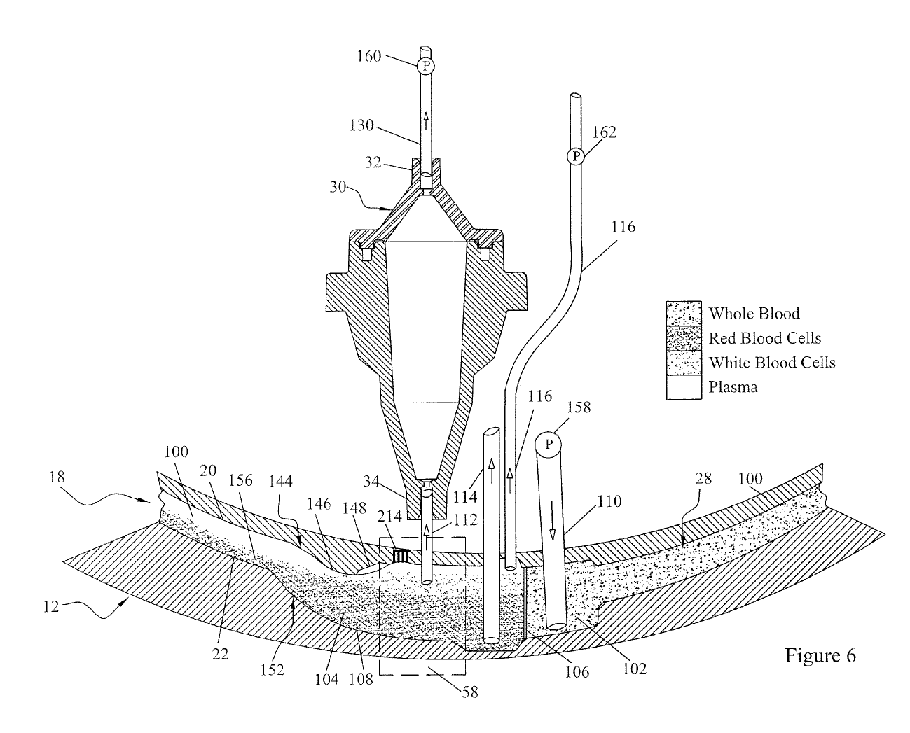

Observation region 58 is positioned on a portion of the density centrifuge 10, preferably on the separation vessel 28. The fluid chamber 30 may also be an observation region, as explained below. In the exemplary embodiment illustrated in FIG. 6, separated blood components and phase boundaries between optically differentiable blood components are viewable in observation region 58. Optionally, the observation region 58 may also be illuminated by an upper light source 62, which is positioned on the same side of the separation chamber as the light collection element 44 and detector 46. Upper light source 62 is positioned such that it generates an incident beam 64, which is scattered by the blood sample and/or centrifuge. A portion of the light from upper light source 62 is collected by light collection element 44 and detected by detector 46, thereby measuring a distribution of scattered and/or transmitted light intensities.

Detector 46 is also capable of generating output signals corresponding to the measured distributions of scattered and/or transmitted light intensities and/or images. The detector 46 is operationally connected to a device controller 60 capable of receiving the output signals. Device controller 60 displays the measured intensity distributions, stores the measured intensity distributions, processes measured intensity distributions in real time, transmits control signals to various optical and mechanical components of the monitoring system and centrifuge or any combination of these. Device controller 60 is operationally connected to centrifuge apparatus 10 and is capable of adjusting selected operating conditions of the centrifuge apparatus, such as the flow rates of cellular and non-cellular components out of the separation vessel 28 or fluid chamber 30, the position of one or more phase boundaries, rotational velocity of the rotor about central rotation axis A-A, the infusion of anticoagulation agents or other blood processing agents to the blood sample, or any combination of these.

Device controller 60 can also be operationally connected to light source 42 and/or upper light source 62. Device controller 60 and/or detector 46 are capable of generating output signals for controlling illumination conditions. For example, output signals from the detector 46 can be used to control the timing of illumination pulses, illumination intensities, the distribution of illumination wavelengths and/or position of light source 42 and/or upper light source 62. Device controller 60 and detector 46 are in two-way communication, and the device controller sends control signals to detector 46 to selectively adjust detector exposure time, detector gain and to switch between monochrome and color imaging.

Light collection element 44, detector 46, or both, can be arranged such that they are moveable, for example moveable along a first detection axis D-D, which is oriented orthogonal to the central rotation axis of the centrifuge. Movement of light collection element 44 in a direction along detection axis D-D adjusts the position of observation region 58 on the density centrifuge. In another embodiment, light collection element 44 is also capable of movement in a direction along a second detection axis (not shown), which is orthogonal to the first detection axis D-D. The present invention also includes an embodiment wherein light source 42, upper light source 62, or both, are also capable of movement in a manner to optimize illumination and subsequent detection of transmitted and/or scattered light from the selectively adjustable observation region.

Light sources comprise light emitting diode sources capable of generating one or more incident beams for illuminating an observation region on the centrifuge. A plurality of lamps may be positioned to illuminate a single side or multiple sides of the centrifuge apparatus 10. Light emitting diodes and arrays of light emitting diode light sources are preferred for some applications because they are capable of generating precisely timed illumination pulses. Preferred light sources generate an incident light beam having a substantially uniform intensity, and a selected wavelength range.

The optical monitoring system comprises a plurality of light sources, each capable of generating an incident light beam having a different wavelength range, for example, a combination of any of the following: white light source, red light source, green light source, blue light source and infra red light source. Use of a combination of light sources having different wavelength ranges is beneficial for discriminating and characterizing separated blood fractions because absorption constants and scattering coefficients of cellular and non-cellular components of blood vary with wavelength. For example, a component containing red blood cells is easily distinguished from platelet-enriched plasma by illumination with light having wavelengths selected over the range of about 500 nm to about 600 nm, because the red blood cell component absorbs light over this wavelength significantly more strongly that the platelet-enriched plasma component. In addition, use of multiple colored light sources provides a means of characterizing the white blood cell type in an extracted blood component. As different white blood cell types have different absorption and scattering cross sections at different wavelengths, monitoring transmitted and/or scattered light from a white cell-containing blood component provides a means of distinguishing the various white blood cell types in a blood component and quantifying the abundance of each cell-type.

The light sources provide a continuous incident light beam or a pulsed incident light beam. Pulsed light sources are switched on and off synchronously with the rotation of the rotor to illuminate an observation region having a substantially fixed position on the rotor. Alternatively, pulsed light sources of the present invention can be configured such that they can be switched on and off in a manner asynchronous with the rotation of the rotor, illuminating different observation regions for each full rotation. This alternative embodiment provides a method of selectively adjusting the location of the observation region and, thereby, probing different regions of the separation chamber or of the fluid chamber 30. Triggering of illumination pulses may be based on the rotational speed of the centrifuge or on the angular position of the separation chamber or the fluid chamber 30 as detected by optical or electronic methods well known in the art. Triggering may be provided by trigger pulses generated by the device controller 60 and/or detector 46.

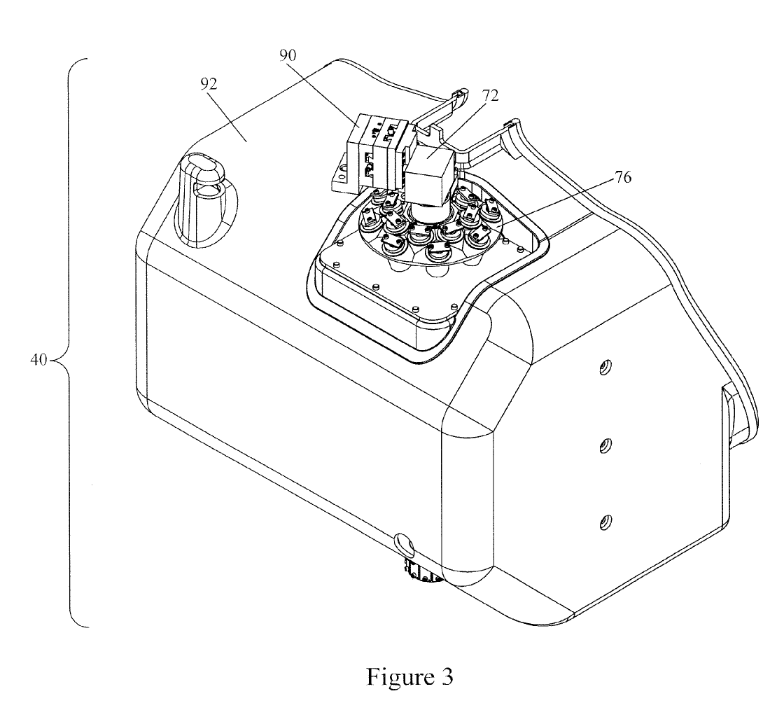

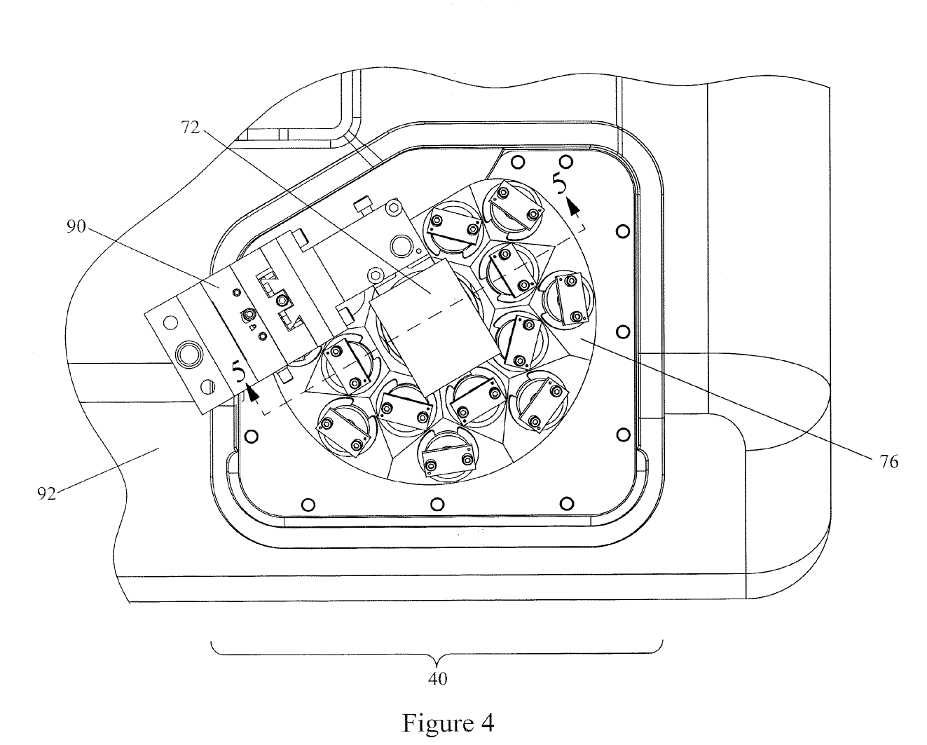

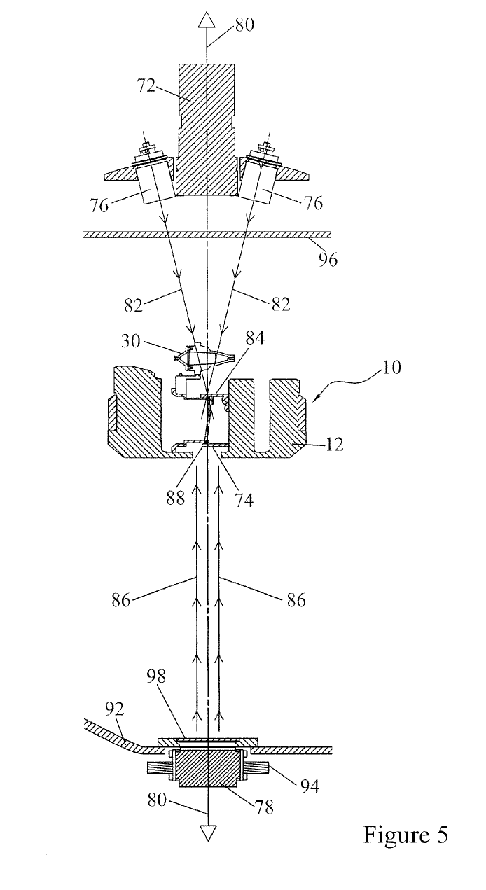

FIG. 3 is a perspective side view of the optical monitoring system 40. FIG. 4 is a top plan view of the optical monitoring system. FIG. 5 is a cutaway view corresponding to cutaway line 5-5 indicated in FIG. 4. The illustrated optical monitoring system 40 comprises CCD camera 72 equipped with a fixed focus lens system (corresponding to the light collection element 44 and detector 46), an optical cell 74 (corresponding to the observation region 58), an upper LED light source 76 (corresponding to the upper light source 62), and a bottom pulsed LED light source 78 (corresponding to the light source 42). As illustrated in FIG. 5, CCD camera 72 is in optical communication with optical cell 74 and positioned to intersect optical axis 80. Upper LED light source 76 is in optical communication with optical cell 74 and is positioned such that it is capable of directing a plurality of collimated upper light beams 82, propagating along propagation axes that intersect optical axis 80, onto the top side 84 of optical cell 74. Bottom pulsed LED light source 78 is also in optical communication with optical cell 74 and is positioned such that it is capable of directing a plurality of collimated bottom light beams 86, propagating along optical axis 80, onto the bottom side 88 of optical cell 74.

CCD camera 72 may be positioned such that the focal plane of the fixed focus lens system is substantially co-planar with selected optical surfaces of optical cell 74, such as optical surfaces corresponding to an interface monitoring region, calibration markers, one or more extraction ports and one or more inlets. The CCD camera 72 is separated from the center of the fixed focus lens system by a distance along optical axis 80 such that an image corresponding to selected optical surfaces of optical cell 74 is provided on the sensing surface of the CCD camera. This optical configuration allows distributions of light intensities comprising images of rotating optical cell 74 or of fluid chamber 30 to be measured and analyzed in real time.

Mounting assembly 90 holds CCD camera 72 in a fixed position. The mounting assembly 90, shown in FIGS. 3 and 4, comprises a bracket capable of maintaining a fixed position and orientation of CCD camera 72. Mounting assembly 90 can also comprise a two-axis locking translation stage, optionally with a two-axis tilting mechanism, capable of selectively adjusting the relative orientation and position of the camera with respect to optical cell 74 or fluid chamber 30. As shown in FIGS. 3-5, optical monitoring system 40 is integrated directly into a centrifuge apparatus 10. To provide good mechanical stability for optical monitoring system 40, mounting assembly 90 is directly affixed to a frame member (not shown in FIGS. 3-5) supporting housing 92 of centrifuge apparatus 10. Bottom LED light source 78 is also affixed to a frame member (not shown in FIGS. 3-5) supporting housing 92 of density centrifuge blood processing device 10 by means of an additional mounting assembly 94. Upper LED light source 76 is secured to CCD camera 72, as shown in FIGS. 3-4. Alternatively, upper LED light source 76 can be directly affixed to a frame member supporting housing 92 of the blood processing device by means of an additional mounting assembly. Mounting assemblies useful in the present invention comprise any fastening means known in the art, such as clamps, brackets, connectors, couplers, additional housing elements and all known equivalents, and can be affixed to frame members supporting housing 92 by any means known in the art including the use of bolts, fasteners, clamps, screws, rivets, seals, joints, couplers or any equivalents of these known in the art.

Referring to the cross section shown in FIG. 5, first transparent plate 96 is provided between CCD camera 72 and optical cell 74, and second transparent plate 98 is provided between bottom LED light source 78 and optical cell 74. First and second transparent plates 96 and 98 physically isolate CCD camera 72, upper LED light source 76 and bottom LED light source 78 from optical cell 74 so that these components will not contact a sample undergoing processing in the event of sample leakage from the separation chamber. In addition, first and second transparent plates 96 and 98 minimize degradation of CCD camera 72, upper LED light source 76 and bottom LED light source 78 due to unwanted deposition of dust and other contaminants that can be introduced to the system upon rotation of the separation chamber and filler. Further, first and second transparent plates 96 and 98 also allow a user to optimize the alignment of the camera, upper LED light source and bottom LED light source without exposure to a blood sample in the separation chamber. First and second transparent plates 96 and 98 can comprise any material capable of transmitting at least a portion of upper and bottom illumination light beams 82 and 86. Exemplary materials for first and second transparent plates 96 and 98 include, but are not limited to, glasses such as optical quality scratch resistant glass, transparent polymeric materials such as transparent plastics, quartz and inorganic salts.

FIG. 6 schematically illustrates a portion of the separation vessel 28 and fluid chamber 30 mounted on the rotor 12. The separation vessel 28 has a generally annular flow path 100 and includes an inlet portion 102 and outlet portion 104. A wall 106 prevents substances from passing directly between the inlet and outlet portions 102 and 104 without first flowing around the generally annular flow path 100 (e.g., counterclockwise in FIG. 6).

A radial outer wall 108 of the separation vessel 28 is positioned closer to the axis of rotation A-A in the inlet portion 102 than in the outlet portion 104. During separation of blood components, this arrangement causes formation of a very thin and rapidly advancing red blood cell bed in the separation vessel 28 between the inlet portion 102 and outlet portion 104. The red blood cell bed reduces the amount of blood components required to initiate a separation procedure, and also decreases the number of unnecessary red blood cells in the separation vessel 28. The red blood cell bed substantially limits or prevents platelets from contacting the radial outer wall 108 of the separation vessel 28. This is believed to reduce clumping of platelets caused when platelets contact structural components of centrifugal separation devices.

The inlet portion 102 includes an inflow tube 110 for conveying a fluid to be separated, such as whole blood, into the separation vessel 28. During a separation procedure, substances entering the inlet portion 102 follow the flow path 100 and stratify according to differences in density in response to rotation of the rotor 12. The outlet portion 104 includes first, second, and third outlet lines 112, 114, 116 for removing separated substances from the separation vessel 28. Preferably, each of the components separated in the vessel 28 is collected and removed in only one area of the vessel 28, namely the outlet portion 104. In addition, the separation vessel 28 preferably includes a substantially constant radius except in the region of the outlet portion 104 where the outer wall of the outlet portion 104 is preferably positioned farther away from the axis of rotation A-A to allow for outlet ports of the lines 112, 114, and 116 to be positioned at different radial distances and to create a collection pool with greater depth for the high density red blood cells. The outlet port of line 114 is farther from the axis of rotation A-A than the other ports to remove higher density components, such as red blood cells. The port of line 116 is located closer to the axis of rotation A-A than the other ports to remove the least dense components separated in the separation vessel 28, such as plasma. The first line 112 collects intermediate density components and, optionally, some of the lower density components. The second and third lines 114 and 116 are positioned downstream from first line 112 to collect the high and low density components.

The positions of the interfaces are controlled by the CCD camera 72 monitoring the position of the interface and controlling flow of liquid and/or particles in response to the monitored position. Further details concerning the structure and operation of the separation vessel 28 are described in U.S. patent application Ser. No. 10/884,877 and also in U.S. Pat. No. 4,094,461 to Kellogg et al. and U.S. Pat. No. 4,647,279 to Mulzet et al., which have been incorporated herein by reference.

A ridge 144 extends from the inner wall 20 of the groove 18 toward the outer wall 22 of the groove 18. When the separation vessel 28 is loaded in the groove 18, the ridge 144 deforms semi-rigid or flexible material in the outlet portion 104 of the separation vessel 28 to form a trap dam 146 in the separation vessel 28, upstream from the first line 112. The trap dam 146 extends away from the axis of rotation A-A to trap a portion of lower density substances, such as priming fluid and/or plasma, along an inner portion of the separation vessel 28 located upstream of the trap dam 146. These trapped substances help convey platelets to the outlet portion 104 and first line 112 by increasing plasma flow velocities next to the layer of red blood cells in the separation vessel 28 to scrub platelets toward the outlet portion 104. A downstream portion 148 of the trap dam 146 has a relatively gradual slope extending in the downstream direction toward the axis of rotation A-A, which limits the number of platelets (intermediate density components) that become re-entrained (mixed) with plasma (lower density components) as plasma flows along the trap dam 146. In addition, the gradual slope of the downstream portion 148 reduces the number of platelets that accumulate in the separation vessel 28 before reaching the first collection port of first line 120.

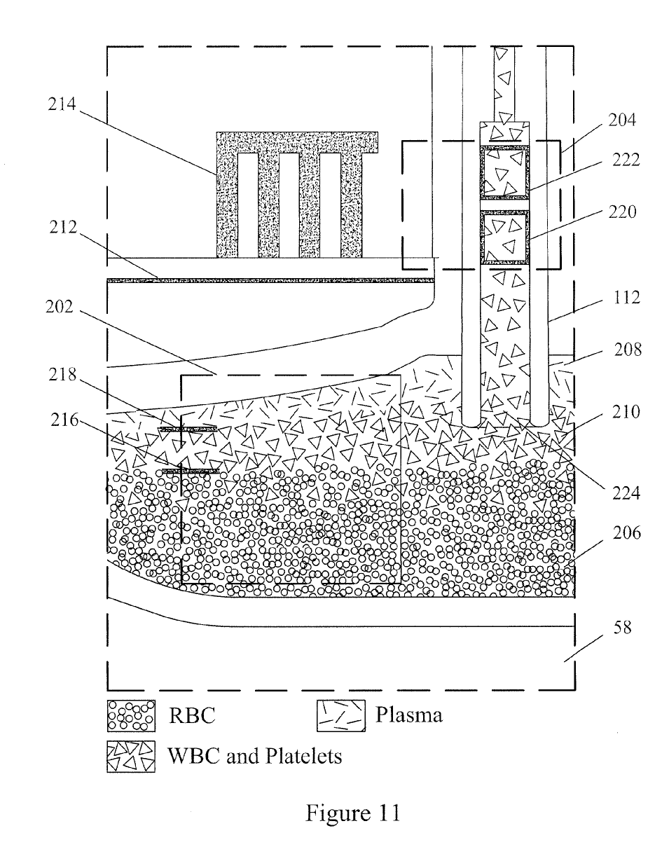

The camera 44 is generally focused on the separation vessel and stroboscopic illumination allows an observation region 58 around the first, second, and third lines 112, 114, and 116 to be observed. Using information gathered through the camera, the controller 60 regulates the position of interfaces between various blood components, such as plasma, buffy coat (containing monocytes and/or white blood cells and platelets) and red blood cells by controlling the pumps 158, 160, and 162. FIG. 11 shows an image of the observation region 58 generated by the methods of U.S. patent application Ser. No. 10/884,877 (incorporated herein by reference) corresponding to the separation of a human blood sample and extraction of a separated white blood cell-containing blood component. The observation region 58 shown in FIG. 11 includes a phase boundary monitoring region 202 and a white blood cell extraction port monitoring region 204. Visible in phase boundary monitoring region 202 are a red blood cell component 206, a plasma component 208 and a mixed-phase buffy coat layer 210, which has both white blood cells and platelets. Several calibration markers are also apparent in the image in FIG. 11. The edge 212 of the optical cell comprises a first calibration marker for determining the absolute position of phase boundaries between optically differentiable blood components. A series of bars 214 having a thickness of 1 mm and known scattering and absorption characteristics comprises a second calibration marker useful for optimizing the focusing of the light collection element and indicating the positions and physical dimensions of the phase boundary monitoring region 202 and the white blood cell extraction port monitoring region 204. Light intensities transmitted through the phase boundary monitoring region 202 are acquired as a function of time and analyzed in real time to provide measurements of the position of the phase boundary 216 between red blood cell component 206 and buffy coat layer 210 and the phase boundary 218 between the buffy coat layer 210 and plasma component 208. All boundary layer positions are measured relative to the edge of the optical cell 212.

White blood cell extraction port monitoring region 204 includes a first flux monitoring region 220 and a second flux monitoring region 222 positioned on first line 112 of the optical cell for extracting white blood cells. In this example, first line 112 having orifice 224 is configured to collect white blood cells in the human blood sample and extends a distance along the separation axis of such that it terminates proximate to the buffy coat layer in the rotating separation chamber. The two-dimensional distribution of light intensities of light transmitted through the first and second flux monitoring regions 220 and 222 depends on the concentration, and spatial distribution and cell-type of cellular material exiting the separation chamber. Light intensities transmitted through and reflected from first and second flux monitoring regions 220 and 222 were acquired as a function of time and analyzed to characterize the composition and flux of cellular material out of the separation chamber. As cellular materials, such as white blood cells and red blood cells, absorb and scatter light from the light sources, passage of cellular material through the extraction port decreases the observed light intensities.

Referring again to FIG. 6, the outer wall 22 of the groove 18 preferably includes a gradual sloped portion 152 facing the ridge 144 in the inner wall 20. When the separation vessel 28 shown in FIG. 9 is loaded in the groove 18, the gradual sloped portion 152 deforms semi-rigid or flexible material in the outlet portion 104 of the separation vessel 28 to form a relatively smooth and gradual sloped segment in a region of the vessel 28 across from the trap dam 146, which slopes gradually away from the axis of rotation A-A to increase the thickness of a layer of high-density fluid components, such as red blood cells, formed across from the trap dam 146.

The first collection line 112 is connected to the fluid chamber inlet 34 to pass the intermediate density components into the fluid chamber 30. Components initially separated in the separation vessel 28 are further separated in the fluid chamber 30. For example, white blood cells could be separated from plasma and platelets in the fluid chamber 30. This further separation preferably takes place by forming a saturated fluidized bed of particles, such as white blood cells, in the fluid chamber 30. The fluid chamber 30 may be formed of a transparent or translucent co-polyester plastic, such as PETG, to allow viewing of the contents within the chamber interior with the aid of the camera during a separation procedure.

As schematically shown in FIG. 6, a plurality of pumps 158, 160, and 162 are provided for adding and removing substances to and from the separation vessel 28 and fluid chamber 30. An inflow pump 158 is coupled to the inflow line 110 to supply the substance to be separated, such as whole blood, to the inlet portion 102. In addition, a first collection pump 160 is flow coupled to the outflow tubing 130 connected to the fluid chamber outlet 32, and a second collection pump 162 is flow coupled to the third collection line 116. The first collection pump 160 draws liquid and particles from the fluid chamber outlet 32 and causes liquid and particles to enter the fluid chamber 30 via the fluid chamber inlet 34. The second collection pump 162, on the other hand, removes primarily low-density substances from the separation vessel 28 via the third line 116.

The pumps 158, 160, and 162 are peristaltic pumps or impeller pumps configured to prevent significant damage to blood components. However, any fluid pumping or drawing device may be provided. In an alternative embodiment (not shown), the first collection pump 160 may be fluidly connected to the fluid chamber inlet 34 to directly move substances into and through the fluid chamber 30. In addition, the pumps 158, 160, and 162 may be mounted at any convenient location. The inflow pump 158 and the first collection pump 160 may be configured so that substances do not bypass these pumps when they are paused. For example, when the first collection pump 160 is temporarily paused, substances pumped by the second collection pump 162 flow into the fluid chamber outlet 32 rather than bypassing the pump 160 and flowing in the opposite direction.

The apparatus 10 further includes a controller 164 (FIG. 1) connected to the motor 14 to control rotational speed of the rotor 12. The controller 164 is connected to the pumps 158,160, and 162 to control the flow rate of substances flowing to and from the separation vessel 28 and the fluid chamber 30. The controller 164 maintains a saturated fluidized bed of first particles within the fluid chamber 30 to aid in second particles being retained in the fluid chamber 30. The controller 164 also preferably controls the operation and flow rate of the pumps 158, 160, 162 to permit the temporary purging of the fluid chamber 30. The controller 164 may include a computer having programmed instructions provided by a ROM or RAM as is commonly known in the art. The controller 164 may vary the rotational speed of the centrifuge rotor 12 by regulating frequency, current, or voltage of the electricity applied to the motor 14. Alternatively, the rotational speed can be varied by shifting the arrangement of a transmission (not shown), such as by changing gearing to alter a rotational coupling between the motor 14 and rotor 12. The controller 164 may receive input from a rotational speed detector (not shown) to constantly monitor the rotation speed of the rotor.

After loading the separation vessel 28 and fluid chamber 30 on the rotor 12, the separation vessel 28 and chamber 30 are initially primed with a low density fluid medium, such as air, saline solution, plasma, or another fluid substance having a density less than or equal to the density of liquid plasma. Alternatively, the priming fluid is whole blood itself. This priming fluid allows for efficient establishment of a saturated fluidized bed of red blood cells within the fluid chamber 30. When saline solution is used, the pump 158 pumps this priming fluid through the inflow line 110 and into the separation vessel 28 via the inlet line 110. The saline solution flows from the inlet portion 102 to the outlet portion 104 (counterclockwise in FIG. 6) and through the fluid chamber 30 when the controller 164 activates the pump 160. Controller 164 also initiates operation of the motor 14 to rotate the centrifuge rotor 12, separation vessel 28, and fluid chamber 30 about the axis of rotation A-A. During rotation, twisting of lines 110, 112, 114, 116, and 130 is prevented by a sealless one-omega/two-omega tubing connection as is known in the art and described in above-mentioned U.S. Pat. No. 4,425,112.

As the separation vessel 28 rotates, a portion of the priming fluid (blood or saline solution) becomes trapped upstream from the trap dam 146 and forms a dome of priming fluid (plasma or saline solution) along an inner wall of the separation vessel 28 upstream from the trap dam 146. After the apparatus 10 is primed, and as the rotor 12 rotates, whole blood or blood components are introduced into the separation vessel 28. When whole blood is used, the whole blood can be added to the separation vessel 28 by transferring the blood directly from a donor or patient through inflow line 110. In the alternative, the blood may be transferred from a container, such as a blood bag, to inflow line 110.

The blood within the separation vessel 28 is subjected to centrifugal force causing components of the blood components to separate. The components of whole blood stratify in order of decreasing density as follows: (1) red blood cells, (2) white blood cells, (3) platelets, and (4) plasma. The controller 164 regulates the rotational speed of the centrifuge rotor 12 to ensure that this particle stratification takes place. A layer of red blood cells (high density component(s)) forms along the outer wall of the separation vessel 28 and a layer of plasma (lower density component(s)) forms along the inner wall of the separation vessel 28. Between these two layers, the intermediate density platelets and white blood cells (intermediate density components) form a buffy coat layer. This separation takes place while the components flow from the inlet portion 102 to the outlet portion 104. Preferably, the radius of the flow path 100 between the inlet and outlet portions 102 and 104 is substantially constant to maintain a steady red blood cell bed in the outlet portion 104 even if flow changes occur.

In the outlet portion 104, platelet poor plasma flows through the third line 116. These relatively low-density substances are pumped by the second collection pump 162 through the third collection line 116. Red blood cells are removed via the second line 114. The red blood cells flow through the second collection line 114 and can then be collected and optionally recombined with other blood components or further separated. Alternately, these removed blood components may be re-infused into a donor or patient.

Accumulated platelets are removed via the first collection line 112 along with some of the white blood cells and plasma. As the platelets, plasma, white blood cells, and possibly a small number or red blood cells pass through the first collection line 112, these components flow into the fluid chamber 30, filled with the priming fluid, so that a saturated fluidized particle bed may be formed. The portion or dome of priming fluid (i.e. saline) trapped along the inner wall of the separation vessel 28 upstream from the trap dam 146 guides platelets so that they flow toward the first collection line 112. The trapped fluid reduces the effective passageway volume and area in the separation vessel 28 and thereby decreases the amount of blood initially required to prime the system in a separation process. The reduced volume and area also induces higher plasma and platelet velocities next to the stratified layer of red blood cells, in particular, to “scrub” platelets toward the first collection line 112. The rapid conveyance of platelets increases the efficiency of collection.

The controller 164 maintains the rotation speed of the rotor 12 within a predetermined rotational speed range to facilitate formation of this saturated fluidized bed. In addition, the controller 164 regulates the pump 160 to convey at least the plasma, platelets, and white blood cells at a predetermined flow rate through the first collection line 112 and into the inlet 34 of the fluid chamber 30. These flowing blood components displace the priming fluid from the fluid chamber 30. When the platelet and white blood cell particles enter the fluid chamber 30, they are subjected to two opposing forces. Plasma flowing through the fluid chamber 30 with the aid of pump 160 establishes a first viscous drag force when plasma flowing through the fluid chamber 30 urges the particles toward the outlet 32. A second centrifugal force created by rotation of the rotor 12 and fluid chamber 30 acts to urge the particles toward the inlet 34.

The controller 164 regulates the rotational speed of the rotor 12 and the flow rate of the pump 160 to collect platelets and white blood cells in the fluid chamber 30. As plasma flows through the fluid chamber 30, the flow velocity of the plasma decreases and reaches a minimum as the plasma flow approaches the maximum cross-sectional area of the fluid chamber 30. Because the rotating centrifuge rotor 12 creates a sufficient gravitational field in the fluid chamber 30, the platelets accumulate near the maximum cross-sectional area of the chamber 30, rather than flowing from the chamber 30 with the plasma. The white blood cells accumulate somewhat radially outward from the maximum cross-sectional area of the chamber 30. However, density inversion tends to mix these particles slightly during this initial establishment of the saturated fluidized particle bed.

The fluid chamber 30 is configured to allow cyclic collection of selected particles, such as white blood cells, followed by efficient evacuation of the cells into a collection bag. In contrast to other chamber designs for forming saturated fluidized beds, the fluid chamber described herein has particular application for the automated collection of blood components in that a bolus of cells having selected characteristics can be collected in the fluid chamber 30 and then flushed with low density fluid into a collection bag and these steps can be repeated multiple times, allowing a larger quantity of the selected cells to be collected from the donor or patient while reducing the amount of time necessary for the donation process. Collection of cells in the fluid chamber can be monitored by the camera 72 and the device controller 60. When a selected quantity of cells have been collected in the fluid chamber 30, the flow of plasma through the chamber can be increased and gravity force reduced and the collected cells can be washed out of the chamber and directed into a collection bag.

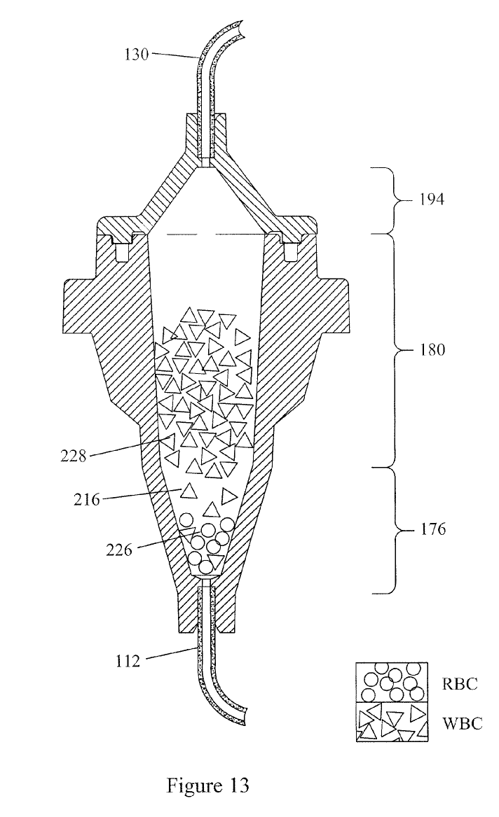

The fluid chamber 30 may be constructed in two pieces, a main body 166 and a cap 168, both being symmetrical around an axis 170. The main body 166 has an inlet 34 comprising a through bore 172 and a concentric stopped bore 174. The diameter of the through bore 172 corresponds to the inside diameter of the first outlet line 112, while the diameter of the stopped bore 174 corresponds to the outside diameter of the first outlet line 112, so that the outlet line 112 can be seated in the stopped bore 174 and a fluid passageway of constant diameter can be formed between the outlet line 112 and the through bore 172. The through bore 172 opens into a first frustro-conical segment 176. A wall 178 of the first frustro-conical segment 176 tapers away from the axis 170 at an angle of about 16°. Immediately adjacent to and down stream from the first frustro-conical segment 176, a second frustro-conical segment 180 extends from the first frustro-conical segment 176 to a distal end 182 of the main body 166. A wall 184 of the second frustro-conical segment 180 tapers away from the axis 170 at an angle of about 3°. As blood components such as plasma, platelets and white blood cells flow into the fluid chamber 30, they are affected by rotational speed, fluid flow rate, and the configuration of the fluid chamber. For example, in a frustro-conical segment, fluid flow rate will decrease as the cross sectional area of the segment increases. At the same time, the blood components may be subject to a centripetal force resulting from the rotation of the apparatus. The centripetal force experienced by a particle in the segment will decrease as the particle moves radially inward toward the axis of rotation. With the proper configuration, a balance of change in forces can be attained such that decreased centripetal force as a particle moves inward is balanced by a corresponding decrease in force of fluid flow. The sizes of white blood cells are distributed about an average size. It has been determined that, for the average size of white blood cells, a increase in cross sectional area represented by a 2.8° taper in the second frustro-conical segment 180 balances the mentioned forces and creates a relatively large area within the fluid chamber 30 where the forces acting on a particle are relatively constant. A slightly larger taper, for example 3° taper, captures slightly larger cells as well, and should be used for that reason. In contrast to the second segment 180, the first segment 176 has a steeper angle and particles in this region are more affected by the change in cross-sectional area than by the change in centripetal force. Particles are pushed through the first segment by fluid flow, gradually slowing as the flow rate diminishes. In the second segment 180, the particles experience substantially constant forces. By altering either the rate of rotation or the fluid flow rate or both the countervailing forces of fluid pushing in and centripetal force pushing out can be balanced for the particular particle of interest. The selected particles begin to enter the fluid chamber 30. Using the camera and techniques explained in U.S. patent application Ser. No. 10/884,877, the flux of cells passing into the fluid chamber 30 can be measured and the controller 60 can calculate the number of blood cells captured in the fluid chamber. Initially, the boundary 216 between red blood cells and the buffy coat can be raised and a few red blood cells can be drawn into the fluid chamber 30. Because of their weight, the red cells collect in the first segment 176, where they form a fluidized bed 226, as shown in FIG. 13. The boundary 216 is then lowered and white cells and plasma are drawn into the fluid chamber 30. As these cells (white blood cells or monocytes) pass through the bed 226 of red cells, the flow velocity across the second segment becomes more uniform across the entire cross-section of the chamber 30. A relatively flat velocity distribution makes it more likely that the desired cells will be captured in the second segment 180. Captured white blood cells begin to form a bolus 228. When the second segment is sufficiently filled with the desired particle, such as white blood cells, the rate of plasma extraction through line 116 can be reduced, for example, from 40 mL/min to 38 mL/min, to lower the interface 218 between plasma and the buffy coat, that is, to move the interface radially outward so that the first outlet line 112 extracts plasma rather than buffy coat. Plasma flowing through the fluid chamber 30 purges the chamber, leaving a concentrated bolus of white blood cells, washed with the donor's plasma. After purging, the flow rate through the chamber 30 can be increased to flush or evacuate the accumulated particles into collection bag by manipulating valves to temporarily direct the fluids leaving the fluid chamber into the collection bag. The angular velocity of the rotor 12 is reduced to decrease the centripetal or gravitational force acting on the fluid and particles. At the same time, the speed of second pump 162 is further decreased, for example, to 33 mL/min, and the speed of first pump 160 is increased to flush the collected white blood cells into the collection bag. Because a cycle of collecting cells in the fluid chamber and evacuating the collected cells to the collection bag can be performed multiple times, a relatively large amount of a rarer blood component, such as white blood cells, can be collected from a single donor or patient.

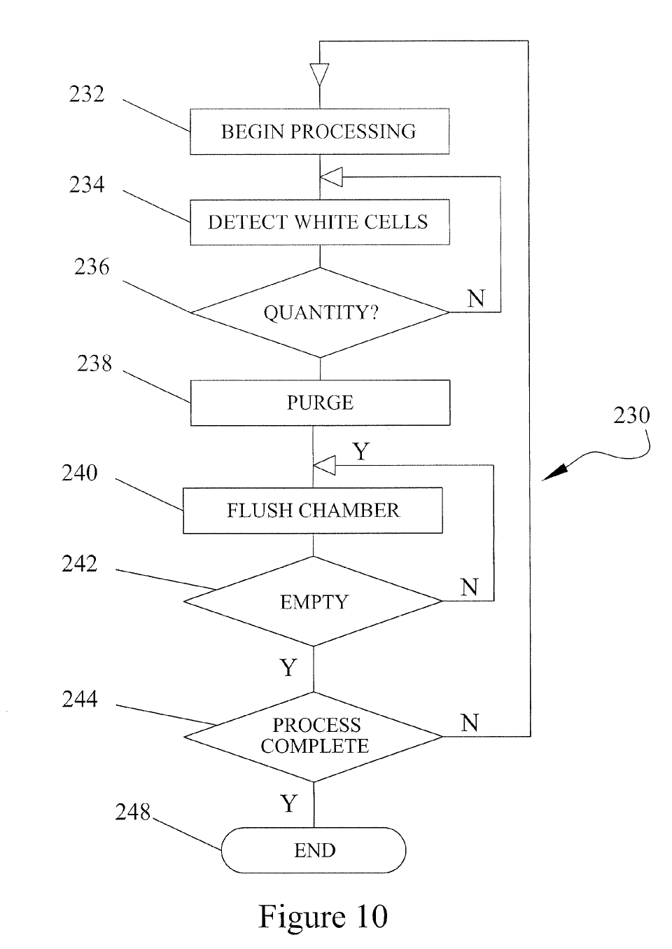

The controller 60 implements a procedure 230 shown in FIG. 10. As explained above, the procedure 230 begins processing 232 by establishing a fluidized bed of a limited quantity of red blood cells in the first segment 176. With the fluidized bed established, the level of the interface 216 is reduced and white cells begin to flow into the fluid chamber 30, and are detected 234 such that the controller 60 can calculate the quantity or number of cells in the fluid chamber. Although the camera views the flow only intermittently because of the stroboscopic lighting, the flow rate through the line 112 is slow (5 mL/min) compared to the rotational speed of the centrifuge (3000 rpm) and the strobe rate of the lighting, so an accurate count of the particles or cells passing through the line 112 can be obtained. The controller 60 determines 236 when a sufficient amount of cells has been collected in the fluid chamber 30, and then purges 238 the cells by lowering the plasma interface 218 and causing plasma to flow through the collected white cells. After this washing, the cells are flushed 240 from the chamber into a collection bag. When the chamber is empty 242, the controller determines 244 if a predetermined quantity of cells has been collected and either ends 248 the procedure, or begins 232 to collect another quantity of cells.

In the illustrated embodiment, the main body 166 of the fluid chamber 30 further comprises a circumferential flange 186, which is supported in the holder 26. The size of the flange may be varied so that different types of fluid chambers can be used in a single centrifuge apparatus. Since certain chambers available from Gambro BCT, Inc. are relatively larger in diameter than the fluid chamber described herein, the flange may be designed to compensate for these differences. A plurality of radial fins 188 is formed proximally from the flange 186. In this embodiment, the fins serve primarily for stability when the fluid chamber 30 is mounted in an existing holder and also as conduits for plastic material during injection molding of the main body 166. At the distal end 182 of the main body 166, a groove 190 secures the cap 168 to the distal end. The cap comprises a rim 191 that fits into the groove 190 and a flange 192 which fits against the distal end of the main body. The cap and main body may be joined by ultrasonic welding, or other suitable technique as known in the art. The cap opens into an abrupt frustro-conical segment 194. The abrupt segment 194 tapers towards the axis 170, the inner wall 196 of the abrupt segment 194 forming a 36° angle with the axis 170. The abrupt segment 194 funnels collected blood components flushed from the second segment 180 into the outlet 32 without excessive turbulence or damage to the blood components. The outlet 34 comprises a through bore 198 and a concentric stopped bore 200. The diameter of the through bore 198 corresponds to the inside diameter of the outflow tubing 130, while the diameter of the stopped bore 200 corresponds to the outside diameter of the outflow tubing 130, so that the outflow tubing 130 can be seated in the stopped bore 200 and a fluid passageway of constant diameter can be formed between the outflow tubing 130 and the through bore 198. The through bore 198 opens into the frustro-conical segment 194.

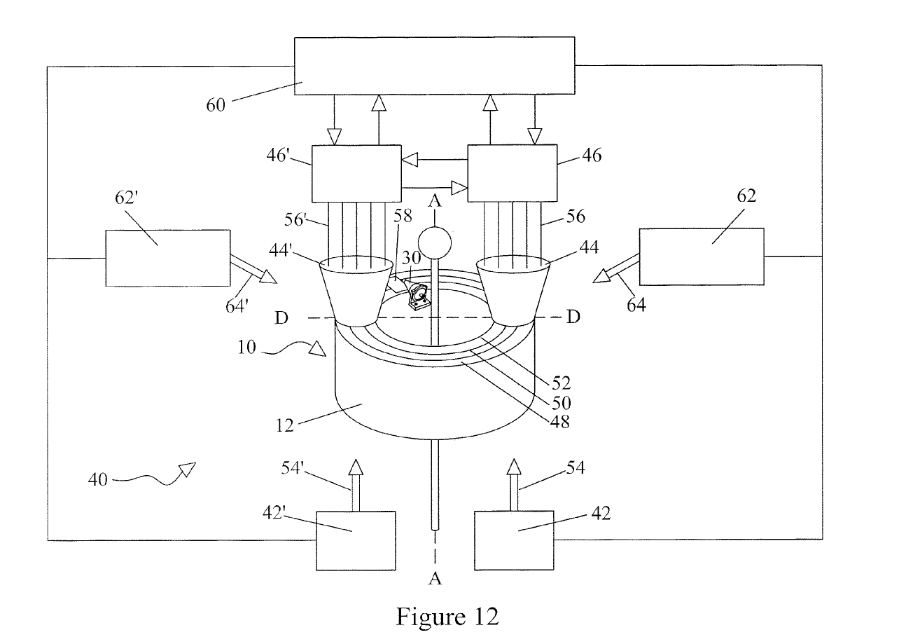

The state of the fluids in the fluid chamber 30 can also be monitored by direct observation. An optical window may be provided in the fluid chamber 30, and the fluid may be monitored by a camera system as described above. A single camera may be automatically re-positioned and re-focused to the desired area of the fluid chamber 30, and the stroboscopic lights synchronized to the radial position of the fluid chamber 30 rather than to the observation region 58. Preferably, however, two camera systems might be used, as illustrated in FIG. 12. A second light collection element or camera 44′ is spaced away from the first camera or light collection element 44 and is focused on the fluid chamber 30, while the first camera 44 is focused on the observation region 58. Lights 42 and 62 illuminate the observation region 58 when it passes under the first camera 44. Lights 42′ and 62′ illuminate the fluid chamber 30 when it passes under the second camera 44′.

As with the system described heretofore, the system for observing the fluid chamber 30 comprises a light source 42′, light collection element 44′, and detector 46′. Light source 42′ is in optical communication with the centrifuge apparatus 10. Light source 42′ provides incident light beam 54′, which illuminates the fluid chamber 30, preferably in a manner generating scattered and/or transmitted light from the fluid in the chamber. In one embodiment, light source 42′ is capable of generating an incident light beam, a portion of which is transmitted through at least one blood component in the fluid chamber 30. At least a portion of scattered and/or transmitted light 56′ from the fluid chamber 30 is collected by light collection element 44′. Light collection element 44′ is capable of directing at least a portion of the collected light 56′ onto detector 46′. The detector 46′ detects patterns of scattered and/or transmitted light 56′ from the fluid chamber 30, thereby measuring distributions of scattered and/or transmitted light intensities. Distributions of scattered and/or transmitted light intensities comprise images corresponding to patterns of light originating from the fluid chamber 30. The images may be monochrome images, which provide a measurement of the brightness of separated blood components along the separation axis. Alternatively, the images may be color images, which provide a measurement of the colors of separated blood components along the separation axis.

Optionally, the fluid chamber 30 can also be illuminated by an upper light source 62′, which is positioned on the same side of the separation chamber as the light collection element 44′ and detector 46′. Upper light source 62′ is positioned such that it generates an incident beam 64′, which is scattered by the blood sample and/or centrifuge. A portion of the light from upper light source 62′ is collected by light collection element 44′ and detected by detector 46′, thereby measuring a distribution of scattered and/or transmitted light intensities. Detector 46′ is also capable of generating output signals corresponding to the measured distributions of scattered and/or transmitted light intensities and/or images. The detector 46′ is operationally connected to the device controller 60, which operates as explained above.

Although the inventive device and method have been described in terms of removing white blood cells and collecting platelets, this description is not to be construed as a limitation on the scope of the invention. The invention may be used to separate any of the particle components of blood from one another or the invention could be used in fields other than blood separation. For example, the saturated fluidized bed may be formed from red blood cells to prevent flow of white blood cells through the fluid chamber 22, so long as the red blood cells do not clump excessively. Alternatively, the liquid for carrying the particles may be saline or another substitute for plasma. In addition, the invention may be practiced to remove white blood cells or other components from a bone marrow harvest collection or an umbilical cord cell collection harvested following birth. In another aspect, the invention can be practiced to collect T cells, stem cells, or tumor cells. Further, one could practice the invention by filtering or separating particles from fluids unrelated to either blood or biologically related substances.

It will be apparent to those skilled in the art that various modifications and variations can be made to the structure and methodology of the present invention without departing from the scope or spirit of the invention. Rather, the invention is intended to cover modifications and variations provided they come within the scope of the following claims and their equivalents.

What is claimed is:

1. An apparatus for separating particles suspended in a fluid, said apparatus comprising
a rotor,
a motor coupled to said rotor and imparting an angular velocity to said rotor, and
a fluid separation chamber mounted on said rotor, said fluid separation chamber having
a fluid inlet and a fluid outlet, said fluid inlet being radially outward from said fluid outlet,
a first frustro-conical segment adjacent said fluid inlet and having a first taper expanding radially inward therefrom,
a second frustro-conical segment immediately adjacent said first frustro-conical segment and expanding radially inward therefrom, said second frustro conical segment having a second taper more acute than said first taper, said second taper being selected such that particles within said second frustro-conical segment are subjected to substantially equal and opposite centripetal and fluid flow forces.

2. The apparatus according to claim 1 wherein the taper of the second frustro-conical segment is selected based on the expected size of particles.

3. The apparatus according to claim 2 wherein the taper of the second frustro-conical segment is selected such that at least particles of the average size of expected particles will be subjected to substantially equal and opposite centripetal and fluid forces.

4. The apparatus according to claim 3 wherein the particles are blood cells.

5. The apparatus according to claim 4 wherein the blood cells are white blood cells.

6. The apparatus according to claim 5 wherein the taper is at least 2.8°.

7. The apparatus according to claim 6 wherein the taper of the second frustro-conical segment is selected such that particles having a size greater than the average size of expected particles will be subjected to substantially equal and opposite centripetal and fluid forces.

8. The apparatus according to claim 7 wherein the taper is about 3.0°.

9. The apparatus according to claim 1 wherein the first frustro-conical segment has a greater taper than the second frustro-conical segment.

10. The apparatus according to claim 1 further comprising
at least one pump controlling a rate of fluid flow through the fluid separation chamber,
a camera configured to observe fluid flow with respect to said fluid separation chamber,
a controller receiving signals from said camera and controlling said motor and said pump whereby particles are selectively captured within said second frustro-conical segment in said fluid separation chamber and flushed out of said fluid separation chamber.

11. The apparatus according to claim 10 wherein said controller calculates the quantity of particles captured within said frustro-conical segment.

12. The apparatus according to claim 11 wherein said camera is configured to observe fluid flow into said fluid separation chamber.

13. The apparatus according to claim 10 further comprising means for determining the quantity of particles captured within said second frustro-conical segment.

14. The apparatus according to claim 13 wherein said controller comprises means for estimating the number of particles of a selected type captured within said fluid separation chamber.

15. The apparatus according to claim 14 wherein said camera is configured to observe fluid flow within said fluid separation chamber.

16. The apparatus according to claim 10 wherein said controller operates said pumps to capture a limited quantity of red blood cells within said first frustro-conical segment before capturing relatively low density particles within said second frustro-conical segment.

17. The apparatus according to claim 10 further comprising means for capturing a limited quantity of relatively high density particles within said first frustro-conical segment before capturing relatively low density particles within said second frustro-conical segment.

18. The apparatus according to claim 17 wherein said relatively high density particles are red blood cells.

19. The apparatus according to claim 18 wherein said relatively low density particles are white blood cells.

20. A method for separating particles suspended in a fluid, said method comprising
separating components of a fluid having particles suspended in said fluid by centripetal force,
passing selected components of said fluid through a fluid separation chamber subjected to centripetal force, said fluid separation chamber having
a fluid inlet and a fluid outlet, said fluid inlet being radially outward from said fluid outlet,
a first frustro-conical segment adjacent said fluid inlet and having a first taper expanding radially inward therefrom,
a second frustro-conical segment immediately adjacent said first frustro-conical segment and expanding radially inward therefrom, said second frustro-conical segment having a second taper more acute than said first taper such that particles with said second frustro-conical segment are subjected to substantially equal and opposite centripetal and fluid flow forces,
collecting particles having selected characteristics primarily in said second frustro-conical segment, and
periodically flushing said collected particles from said fluid separation chamber.

21. The method according to claim 20 further comprising selecting the taper of the second frustro-conical segment based on the expected size of particles.

22. The method according to claim 21 further comprising selecting the taper of the second frustro-conical segment such that at least particles of the average size of expected particles will be subjected to substantially equal and opposite centripetal and fluid forces.

23. The method according to claim 22 wherein the particles are blood cells.

24. The method according to claim 23 wherein the blood cells are white blood cells.

25. The method according to claim 24 wherein the taper is at least 2.8°.

26. The method according to claim 25 further comprising selecting the taper of the second frustro-conical segment such that particles having a size greater than the average size of expected particles will be subjected to substantially equal and opposite centripetal and fluid forces.

27. The method according to claim 26 wherein the taper is about 3.00.

28. The method according to claim 20 further comprising
controlling a rate of fluid flow through the fluid separation chamber,
observing fluid flow with respect to said fluid separation chamber with a camera,
receiving signals from said camera, and
controlling centripetal forces and fluid flow rate whereby particles are selectively captured within said second frustro-conical segment in said fluid separation chamber and flushed out of said fluid separation chamber.

29. The method according to claim 28 further comprising determining the quantity of particles captured within said second frustro-conical segment.

30. The method according to claim 29 further comprising estimating the number of particles of a selected type captured within said fluid separation chamber.

31. The method according to claim 30 further comprising capturing a limited quantity of relatively high density particles within said first frustro-conical segment before capturing relatively low density particles within said second frustro-conical segment.

32. The method according to claim 31 wherein said relatively high density particles are red blood cells.

33. The method according to claim 32 wherein said relatively low density particles are white blood cells.

34. The method according to claim 20 further comprising capturing a limited quantity of relatively high density particles within said first frustro-conical segment before capturing relatively low density particles within said second frustro-conical segment.

35. The method according to claim 34 wherein said relatively high density particles are red blood cells.

36. The method according to claim 35 wherein said relatively low density particles are white blood cells.

37. A disposable separation chamber for use with an apparatus for separating particles suspended in a fluid, said chamber comprising
a fluid separation bag adapted to be mounted on a rotor, and
a fluid separation chamber in fluid communication with said fluid separation bag; said fluid separation chamber having
a fluid inlet and a fluid outlet, said fluid inlet being radially outward from said fluid outlet,
a first frustro-conical segment adjacent said fluid inlet and having a first taper expanding radially inward therefrom,
a second frustro-conical segment immediately adjacent said first frustro-conical segment and expanding radially inward therefrom, said second frustro conical segment having a second taper more acute than said first taper, said second taper being selected such that particles within said second frustro-conical segment are subjected to substantially equal and opposite centripetal and fluid flow forces.

38. The disposable separation chamber according to claim 37 wherein the taper of the second frustro-conical segment is selected based on the expected size of particles.

39. The disposable separation chamber according to claim 38 wherein the taper of the second frustro-conical segment is selected such that at least particles of the average size of expected particles will be subjected to substantially equal and opposite centripetal and fluid forces.

40. The disposable separation chamber according to claim 39 wherein the taper is at least 2.8°.

41. The disposable separation chamber according to claim 40 wherein the taper of the second frustro-conical segment is selected such that particles having a size greater than the average size of expected particles will be subjected to substantially equal and opposite centripetal and fluid forces.

42. The disposable separation chamber according to claim 41 wherein the taper is about 3.0°.

43. The disposable separation chamber according to claim 37 wherein the first frustro-conical segment has a greater taper than the second frustro-conical segment.

44. The disposable separation chamber according to claim 37 further comprising
at least one pump controlling a rate of fluid flow through the fluid separation chamber,
a camera configured to observe fluid flow with respect to said fluid separation chamber,
a controller receiving signals from said camera and controlling said motor and said pump whereby particles are selectively captured within said second frustro-conical segment in said fluid separation chamber and flushed out of said fluid separation chamber.

45. The disposable of claim 37 further comprising a plurality of ports, said ports being only an inlet port, a high density fluid outlet port, a medium density fluid outlet port, and a low density fluid outlet port.
